(19) United States
(12) Patent Application Publication
(10) Pub. No.: US 2003/0222772 A1
(43) Pub. Date: Dec. 4, 2003

(54) Vehicle proximity warning detector

(75) Inventor: Zohar Laufer, Karmiel (IL)

Correspondence Address: BROWDY AND NEIMARK, P.L.L.C., 624 NINTH STREET, NW, SUITE 300, WASHINGTON, DC, 20001-5303, US

(73) Assignee: Zohar Lightomatic Ltd., Karmiel (IL)

(21) Appl. No.: 10/155,235

(22) Filed: May 28, 2002

(51) Int. Cl. B60Q 1/00

(52) U.S. Cl. 340/435

(57) ABSTRACT

A proximity detector comprising, at least one transmitter unit to transmit radiation toward a zone of interest and at least one receiver unit to receive radiation originating from the transmitter and that is reflected back from an obstacle at the zone of interest. A light-transmitter associated with each transmitter unit and a receiver light-transmitter associated with each receiver unit, a control module for controlling, processing a signal received from the receiver unit, to produce a signal responsive to the proximity of the obstacle. The light-transmitters are light-guides made of a rigid and at least translucent material.

### FIELD OF THE INVENTION

This invention relates to vehicle safety devices and, in particular, it concerns a proximity warning device for warning of an obstacle adjacent to a vehicle that can be compactly integrated within an assembly of the vehicle, e.g. a lamp assembly, a license plate frame, a bumper, etc. The term vehicle as used herein the specification and claims collectively refers to any type of land, marine or air-borne vehicles. The device is also suitable for use as a proximity detector for stationary objects, e.g. buildings, etc.

### BACKGROUND OF THE INVENTION

Several devices have been suggested for detecting and warning a driver of the presence of stationary or moving obstacles adjacent a vehicle.

Examples of active optical devices in which a signal, typically infrared, is transmitted towards the zone of interest and reflected signals are received are described in U.S. Pat. No. 6,150,956 to the present inventor Laufer, GB Patent No. 2243511 to Jackson and U.S. Patent Application 2001/0043142 to Milliken.

In U.S. Pat. No. 6,150,956, there is disclosed a proximity device with special filtering to allow operation in a wide variety of lighting conditions that also provides complete and reliable coverage of a well-defined zone adjacent the vehicle. Therein an enablement of an electronic system for a proximity device is disclosed the features of which are incorporated herein by reference. However, this patent does not describe how the device is mechanically integrated to the vehicle.

In GB Patent No. 2243511, there is described a proximity detector apparatus comprising a transmitter, and a receiver therefor, and a carrier that contains the transmitter and receiver. The carrier, upon which the apparatus is mounted, is in the form of an elongate carrier that may be a vehicle bumper or a number plate for the vehicle. The apparatus is therefore not a part of an electrically powered sub-system and requires auxiliary wiring—and possibly other associated hardware—and the apparatus protrudes relative to standard vehicle components.

U.S. Patent Application 2001/0043142 describes a vehicle back-up alarm in combination with a housing that may include a vehicle back-up light. A single housing may contain an alarm, sensor, and one of a variety of warning devices (e.g. audible, distance sensing, visual/light, etc.). The housing includes mounting aids as it is designed to be incorporated as an auxiliary device particularly with vehicles requiring audible back-up alarms such as commercial vehicles, garbage and delivery trucks, and the like. The invention is not amenable to integrating within the original design of the vehicle. The device therefore requires an additional mounting area and wiring and is aesthetically different than the original vehicle.

It is therefore an object of the invention to provide a proximity warning detector, in particular one suited for vehicles, overcoming issues of the prior art, whereby a proximity warning detector is compactly integrated into an assembly of the vehicle.

### SUMMARY OF THE INVENTION

According to the present invention, the warning detector is integrated within an external assembly of a vehicle and a receiver of the detector is optically coupled to a cover of the assembly by means of a light-guide or light-pipe. A suitable alarm signal or other indications are transmitted to the driver. In this manner the proximity detector is compactly contained within an already existing vehicle sub-system and the aesthetics of the vehicle are unchanged.

The term light guide or light-pipe refers to an optical conductor made of a rigid light-conducting material e.g. polymeric or glass, and where it is so designed that it essentially isolates signals transmitted/received therethrough from environment light, so as to minimize distortion of the signals.

The proximity detector of the present invention is designed to be a detector with low signal distortion that fits into an existing external assembly of a vehicle without protruding or changing the aesthetics of the vehicle, in a manner such that it is modular in conjunction with the external assembly such that the detector may be installed at the time of initial vehicle assembly or as a replacement part (i.e. retro-fitable). The detector may be easily and fast assembled in a vehicle.

A light guide according to the present invention is made of a rigid, at least translucent material, and may have different section shapes. According to one particular the light guide has a cylindrical cross section, though it may also be flat or any other polygonal shape. It may be a solid member or tubular (i.e. having an void extending at least part the length of the light guide), and it may be of uniform dimensions along the longitudinal axis thereof or may be tapering.

According to one particular embodiment of the present invention, the external assembly fitted with the warning detector is a vehicles lamp, where a transmitter and a receiver of the detector are optically integrated with a cover of the lamp assembly. However, according to modifications of the invention, the external assembly may be a license plate holder frame of the vehicle, a bumper of the vehicle, etc.

According to one feature of the present invention, there is provided a proximity warning detector, housed within an external assembly, for warning of the proximity of an obstacle within a zone of interest, said detector comprising at least one transmitter unit to transmit radiation signals toward said zone of interest via corresponding at least one transmitter light-guides, and at least one receiver unit to receive radiation signals originating from the transmitter that is reflected back from said obstacle through corresponding at least one receiver light-guides; and a control module that processes said signal of said receiver to produce an output in relation to the proximity of the obstacle.

Where the external assembly is a lamp assembly, the proximity detector comprises a control module residing behind a reflector of the lamp assembly and comprising at least one transmitter unit, each associated with a transmitter light-guide, and at least one sensor, each associated with a receiver light-guide; said light-guides optically connect the respective at least one transmitter and the at least one sensor with a zone of interest adjacent to the vehicle, to thereby facilitate transmittance of optical signals.

According to one embodiment, the optical signals are electromagnetic radiation signals.

The light-guide may have a reflective coating to further prevent radiation of adjacent light sources, e.g. bulbs of the lamp assembly, from distorting the optical signal passed from the lens to the control module.

The detector may have an array of transmitters and receivers such that the sight angle of the transmitted and received radiation is relatively wide.

According to a preferred embodiment of the invention, the at least one transmitter light-guide has a cylindrical cross section, and the at least one receiver light-guide has a tapering cross section, where a narrower end thereof extends adjacent the receiver unit.

The at least one transmitter and receiver light-guides extend between a distal end, i.e. facing the zone of interest, and a proximal end, i.e. adjacent the respective at least one transmitter and receiver. Preferably, the proximal end of both the transmitter and receiver light-guides is formed with a receptacle nesting a respective transmitter/receiver.

The light-guides may be integrally molded with the external frame (e.g. of the lamp assembly) or may be fixedly attached thereto. The light-guides may be colored (e.g. as of the color of the lamp frame), though it is preferable that they be clear.

While the proximity alarm of the present invention may have other applications, such as in conjunction with a home or building security system, where the device may be incorporated in one or several exterior and/or interior house or building lights, the invention is herein described in relation to its primary intended use; with regard to vehicles. It is further to be noted that the device is suitable for fitting in any lamp assembly of the vehicle, e.g. tail-light, front-light (headlight), indicator (side light), etc.

For sake of example only, the present invention may be relate to the integration of the components of a proximity detector using a system whose details are disclosed in U.S. Pat. No. 6,150,956.

Additional features and possible modifications will be presented and will become obvious based on the detailed description below.

### BRIEF DESCRIPTION OF THE DRAWINGS

In order to understand the invention and to see how it may be carried out in practice, several embodiments will now be described, by way of non-limiting examples only, with reference to the accompanying drawings, in which:

FIG. 1 is a sectioned top view of a vehicle lamp assembly containing a proximity warning detector according to one application of the invention;

FIGS. 2A and 2B are sectioned top views of a cover of a vehicle lamp assembly fitted with light-guides, according to several embodiments of the present invention;

FIGS. 3A to 3D are schematic representations of different embodiments of transmitter and receiver light-guides, respectively;

FIG. 4 is a top view of a light-guide in accordance with an embodiment of the invention; and

FIG. 5 is a sectioned top view of a vehicle lamp assembly illustrating another embodiment of a light-transmitting unit according to the present invention.

### DETAILED DESCRIPTION OF THE INVENTION

The present invention is a proximity warning detector, particularly suited for vehicles, though, as already mentioned before, may also be suited for other purposes e.g. integration within alight source which automatically lights upon sensing a nearing object, etc.

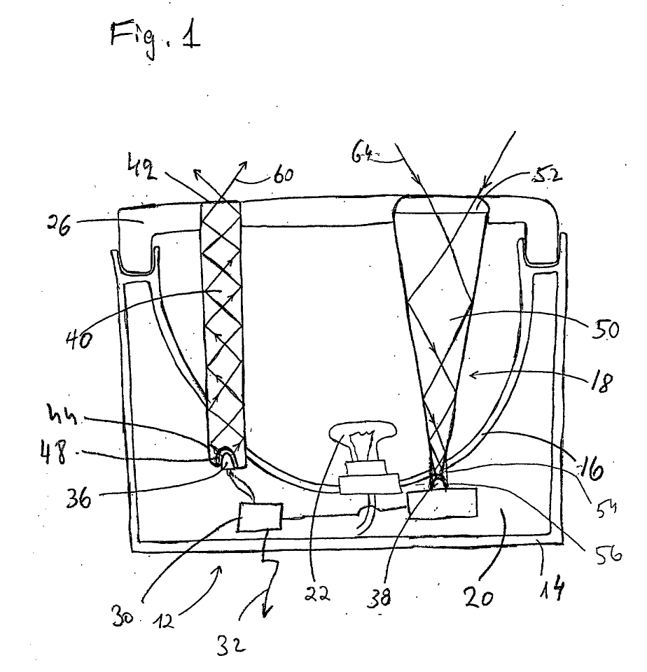

An embodiment of the present invention is now described with reference to FIG. 1 illustrating a top view of a vehicle lamp assembly comprising a proximity warning detector assembly, generally designated 10, housed within a lamp assembly generally designated 12.

The lamp assembly 12 comprises a housing 14, a reflective plate 16 dividing the lamp into a front chamber 18 and a rear chamber 20. A light bulb 22 projecting into the front chamber 28 and connected to a power supply as known per se. A lamp cover 26 is connected to, or integrally formed with, the housing. In the present example, the lamp assembly is of simple design and shape, illustrates only a single light bulb 22 and having a flat cover 26. However, it should be appreciated that the invention is applicable in any form and design of lamp assemblies.

Warning detector assembly 10 comprises a control module 30 received at the rear chamber 20 and which is adapted for controlling the warning detector system, processing the signals and generating corresponding warning signals, e.g. by transmitting an alarm signal 32 to a driver of a reversing vehicle, etc. A transmitter unit 36 in the form of a LED, is electrically coupled to the control module 30 and a receiver unit 38, in the form of a photodiode (having a general shape of an LED), is also electrically coupled to the control module 30.

Both the transmitter unit 36 and receiver unit 38 are received at the rear chamber 20 to eliminate the signal distortion that can result due to radiation from the bulb 22 of the lamp assembly 12.

A transmitter light-guide 40 has a proximal end thereof 42 fixed to the lamp cover 26, said proximal end 42 being flush with the surface of the lamp cover 26. A distal end 44 of the transmitter light-guide 40 extends to the rear chamber 20 and is formed with a receptacle 48 snugly receiving the transmitter unit 36. Similarly, a receiver light-guide 50 has a proximal end thereof 52 fixed to the lamp cover 26, said proximal end 52 being flush with the surface of the lamp cover 26. A distal end 54 of the receiver light-guide 50 extends to the rear chamber 20 and is formed with a receptacle 58 snugly receiving the transmitter unit 38.

Transmitter and receiver Light-guides 40 and 50 respectively, are made of a rigid tube of clear material, plastic in the present example, with an envelope thereof being essentially smooth, so as to minimize optical interference and distortion by ambient light (e.g. light bulb 22). The light-guides may be colored (e.g. as of the color of the lamp frame), though it is preferable that they be clear.

Radiation from the transmitter unit 36 is directed down the length of the transmitter light-guide 40 and disperses out from the lamp cover 26 as illustarted by arrows 60. The radiation emitted by the transmitter unit 36 reflects off potential obstacles in a zone of interest, e.g. behind a reversing vehicle. Some of the radiation that reflects off an obstacle (not shown) returns to the proximal end 52 of the receiver light-guide 50, as illustrated by arrows 64, after which the light-guide 50 directs the radiation to the receiver unit 38, which then emits a radiation signal to the control module 30.

A signal 32 from the control module 30 to the vehicle driver (not shown) completes the detection and warning process. The signal to alert the driver of an impending obstacle could take the form of an audio, visual or other signal, as known in the art.

To improve the reception of reflected radiation from obstacles the receiver light-guide 50 is typically of a conical shape with the distal end, conforming with the size of the receiver unit 38, whereby essentially all the reflected radiation is directed towards the receiver unit. Arrows 64 show how the radiation converges through the light-guide 50 toward its distal end 54.

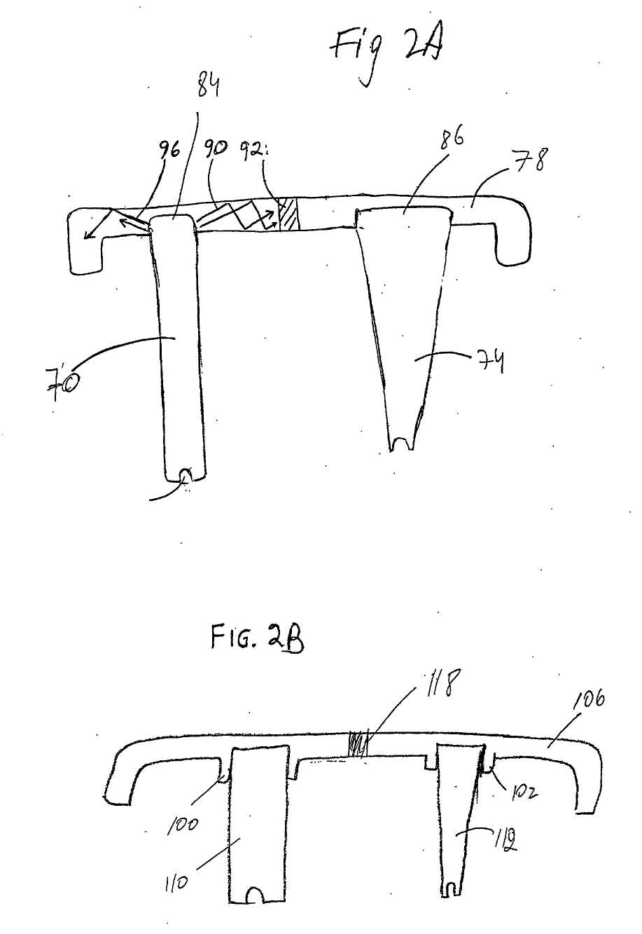

FIG. 2A shows an alternate embodiment of the invention wherein only relevant elements are shown. A transmitter light-guide 70 and a receiver light-guide 74 are disposed in-board of a lamp cover 78. The light-guides 70 and 74 can be connected to, or integrally formed with, the lamp cover 78.

In the configuration it is important to optically separate the proximal ends 84 and 86 of the light-guides 70 and 74, respectively since radiation from the proximal end 84 of transmitter light-guide 70 could otherwise be transmitted laterally (“leak”) via the cover 78 into the proximal end 86 of the receiver light-guide 74, as illustrated by arrows 90. To this end there is formed an optical barrier 92 in the form of an opaque wall portion. However, optical separation may also be accomplished by simply locating the transmitter light-guide and the receiver light-guide at a sufficient distance from one another and possibly by forming optical barriers in the lamp cover in the form of geometrical obstacles (e.g. in the form of two adjoining though separate, lamp frames constituting part of a lamp assembly).

There may also be some radiation loss in other directions as shown by arrows 96. This radiation loss, shown by arrows 96, does not negatively effect the operation of the warning detector although this radiation is not available to be reflected off of obstacles.

The embodiment of FIG. 2B is similar to the embodiment of FIG. 2A, with the addition of peripheral Lugs 100 and 102 integrally extending from the lamp cover 106, wherein the light-guides 110 and 112, respectively, are fixedly attached to the is lugs, e.g. by adhering, heat welding, etc. similarly, there is formed an optical barrier 118 in the form of an opaque wall portion.

In the embodiments related to FIGS. 1 and 2A, where there is only one, their positioning with respect to each other may change. In other words, transmitter light-guide and one receiver light-guide can be in a side-by-side relation, one above the other, vice versa, etc.

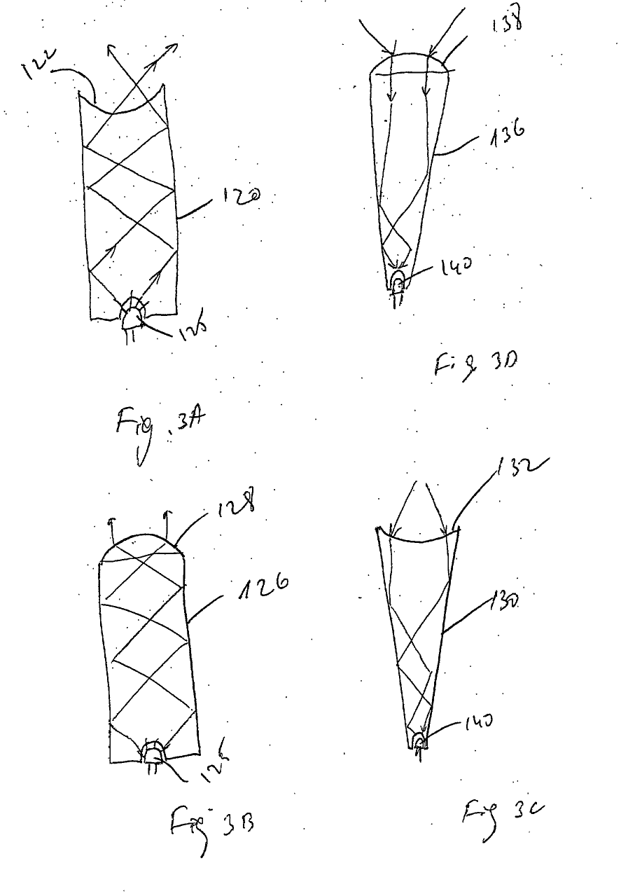

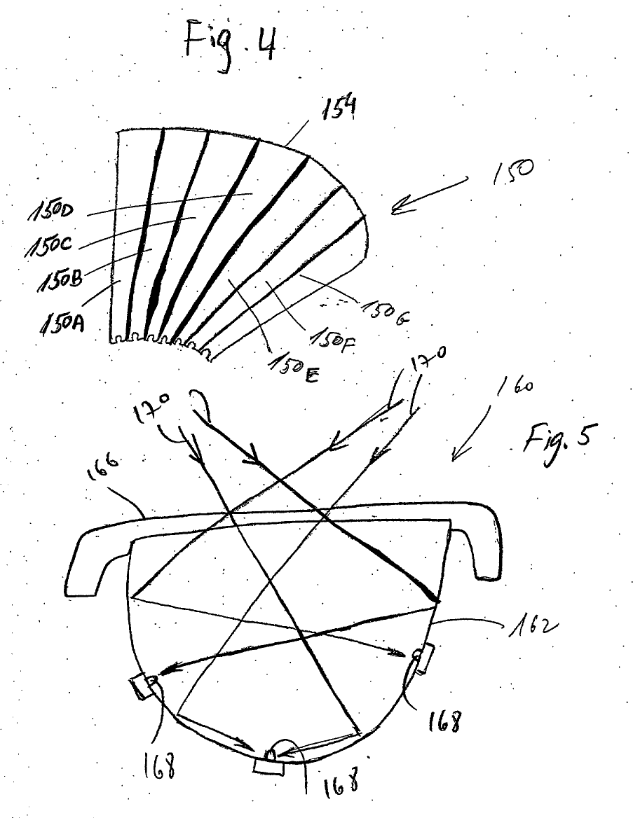

Turning now to FIGS. 3A and 3B are illustrated alternative embodiments of a transmitter light-guide. In FIG. 3A transmitter light-guide 120 is formed with a convex proximal end 122. In FIG. 3B the transmitter light-guide 126 is formed with a concave proximal end 128. In both embodiments, arrowed lines illustrate radiation emitted from a transmitter LED 125 and its path through the respective light-guide.

FIGS. 3C and 3D are illustrated alternative embodiments of a receiver light-guide. In FIG. 3C transmitter light-guide 130 is formed with a convex proximal end 132. In FIG. 3D the receiver light-guide 136 is formed with a concave proximal end 138. In both embodiments, arrowed lines illustrate radiation reflected towards the proximal end its path through the respective light-guide towards a receiver unit 140.

For providing adequate optical coverage, there may be provided several assemblies as disclosed above, or there may be arrangements in which a lamp assembly will comprise a plurality of receiver and transmitter units, each associated with a respective light-guide distributed in the lamp housing. According to another embodiment, the respective light-guides are arranged in a fan-like configuration, as illustrated in FIG. 4. The element in FIG. 4 is a top view of a multiple receiver unit light-guide array, in this particular example fitted for assembly in a left-hand rear lamp assembly of a vehicle. Typically there will be provided at least one such receiver light-guide array and at least one corresponding transmitter light-guide array (not shown). The light-guide array 150 in FIG. 4 is formed of a plurality of coextending light-guide units 150A-150G, each extending between a proximal end flush with a that of a neighboring unit, so as to give rise to a proximal end 154 conforming with the shape of the lamp cover (not shown). It is essential that between each of the light-guides 150A-150G there be provided an optical barrier, as disclosed hereinabove, to prevent radiation ‘leak’ between the neighboring light-guides.

In FIG. 5 there is illustrated a vehicle lamp assembly generally designated 160 in which an essentially flat receiver light-guide 162 (receiver only shown), which is integral with or securely attached to the lamp cover 166. Three receiver units 168 are fitted to said light-guide 162 and the arrangement is such that radiation reflected off an obstacle (not shown) returns to the receiver light-guide 162 and is reflected towards the receiver units 168, as illustrated by arrowed lines 170. A similar arrangement may be formed also for the transmitting light-guides (not shown).

According to still an embodiment of the invention, the light guides are RF-isolated, e.g. by applying a wire mesh over the light guide (not shown), so as to eliminate or reduce signal distortion caused by RF interferences.

It will be appreciated that the above descriptions are intended only to serve as examples, and that many other embodiments are possible, without departing from the spirit and the scope of the present invention.

1. A proximity detector, housed within a lamp assembly, for detecting the proximity of an obstacle within a zone of interest, said detector comprising, at least one transmitter unit to transmit radiation toward said zone of interest; at least one receiver unit to receive radiation originating from the transmitter and that is reflected back from said obstacle; a light-transmitter associated with each transmitter unit and a receiver light-transmitter associated with each receiver unit, a control module for controlling, processing a signal received from the receiver unit, to produce a signal responsive to the proximity of said obstacle; wherein said light-transmitters are light-guides made of a rigid and at least translucent material.

2. A proximity detector according to claim 1, wherein the light guides extend between a proximal end facing the zone of interest, and a distal end adjoining the at least one transmitter unit and the at least one receiver unit, respectively.

3. A proximity detector according to claim 1, wherein the distal end of the light guides is fitted with a receptacle for nesting a transmitter unit or a receiver unit, respectively.

4. A proximity detector according to claim 1, wherein the lamp assembly comprises a front chamber accommodating one or more light-bulbs, and a rear chamber, optically isolated from one another, where the a distal end of the light guides extends at said rear chamber.

5. A proximity detector according to claim 1, wherein a proximal end of at least one of the light guides is flush with an outside face of a lamp cover of the lamp assembly.

6. A proximity detector according to claim 1, wherein a proximal end of at least one of the light guides is received within a lamp cover of the lamp assembly.

7. A proximity detector according to claim 6, wherein a support rim extends from an inside face of the lamp cover, to thereby support a light guide.

8. A proximity detector according to claim 1, wherein the light-guide associated with the receiver unit has a cross-section tapering towards the receiver unit end.

9. A proximity detector according to claim 2, wherein the light guides are integral with a lamp cover of thy lamp assembly.

10. A proximity detector according to claim 1, wherein the surface of the light guides is essentially smooth and clear of defects.

11. A proximity detector according to claim 1, wherein the surface of the light guides has an opaque layer.

12. A proximity detector according to claim 1, wherein the proximal end of neighboring transmitter unit light-guides and receiver unit light-guides are optically isolated.

13. A proximity detector according to claim 12, wherein intermediate neighboring transmitter unit light-guides and receiver unit light-guides received in a lamp cover of the lamp assembly, there is formed an optical barrier, to reduce direct radiation between the proximal ends.

14. A proximity detector according to claim 1, wherein the control module is received within the rear chamber.

15. A proximity detector according to claim 1, wherein the at least one transmitter light-guide is cylindrical.

16. A proximity detector according to claim 1, wherein the at least one transmitter light-guide is polygonal.

17. A proximity detector according to claim 1, wherein the at least one transmitter light-guide is solid.

18. A proximity detector according to claim 1, wherein the at least one transmitter light-guide is at least partially hollow.

19. A proximity detector according to claim 1, wherein one or both of the at least one transmitter light-guide and the at least one receiver light-guide are multiply configured in a fanning configuration.

20. A proximity detector according to claim 19, wherein neighboring light-guides of a multiply configured light-guide are optically isolated from one another.

21. A proximity detector according to claim 1, wherein the lamp assembly is a module disposable within an existing vehicle light assembly.

22. A proximity detector according to claim 1, wherein the lamp assembly is a taillight of a vehicle.

23. A detector according to claim 1, wherein the lamp assembly is light system of a structure.

24. A proximity detector according to claim 23, wherein the signal produced by the control module is activates the light bulb of the light system.

25. A proximity detector according to claim 1, wherein the at least one transmitter unit is an infrared transmitter.

26. A proximity detector according to claim 1, wherein the at least one transmitter unit is an electromagnetic transmitter.

27. A detector according to claim 1, wherein the power supply is supplied by the same power supply as to a back-up lamp assembly.

28. A proximity detector according to claim 1, wherein there is an optical separation between the at least one transmitter light-guide and the at least one receiver light-guide

29. A proximity detector according to claim 28, wherein the separation is a physical barrier.

30. A proximity detector according to claim 28, wherein the optical separation results from one or more bends in a cover of the lamp assembly between the at least one transmitter and the at least one light-pipe.

31. A proximity detector according to claim 1, wherein the detector is designed to be retro-fitable or factory-equipped in a lamp assembly of a vehicle.

32. A proximity detector according to claim 1, wherein the detector is designed to be retro-fitable or factory-equipped in a bumper of a vehicle.

33. A proximity detector according to claim 1, wherein the detector is designed to be retro-fitable or factory-equipped in a fender of a vehicle.

34. A lamp assembly comprising a housing formed with a reflector dividing the housing into a front chamber and a rear chamber, and front cover; at least one transmitter light-guide and a corresponding at least one receiver light-guide extending from the front cover to the rear chamber.

35. A lamp assembly according to claim 34, wherein the light-guides are made of a rigid and at least translucent material.

36. A lamp assembly according to claim 34, wherein the at least one receiver light-guide tapers towards a rear end disposed at the rear chamber.

37. A lamp assembly according to claim 34, wherein a transmitter unit is associated with each transmitter light-guide to transmit radiation toward a zone of interest; and a receiver unit is associated with each receiver light-guide, to receive radiation originating from the transmitter unit and that is reflected back from an obstacle positioned at a zone of interest, and a control module for controlling, processing a signal received from the receiver unit, to produce a signal responsive to the proximity of said obstacle; said control module fitted at the rear chamber.

38. A lamp assembly according to claim 34, wherein the at least one receiver light-guide tapers towards a rear end received at the rear chamber.

39. A lamp assembly according to claim 34, wherein the at least one transmitter light-guide is cylindrical.

40. A lamp assembly according to claim 34, wherein the at least one light-guide are formed at a rear end thereof, received at the rear chamber, with a receptacle for nesting light transmitting or receiving unit.
